(19) United States
(12) Patent Application Publication
(10) Pub. No.: US 2010/0108417 A1
(43) Pub. Date: May 6, 2010

(54) PARALLEL POWER SUPPLIES FOR HEV APPLICATIONS

(76) Inventor: Curt Douglas Gilmore, Fenton, MI (US)

Correspondence Address: HARNESS, DICKEY & PIERCE, P.L.C., P.O. BOX 828, BLOOMFIELD HILLS, MI, 48303, US

(21) Appl. No.: 12/606,690

(22) Filed: Oct. 27, 2009

Related U.S. Application Data
(60) Provisional application No. 61/110,270, filed on Oct. 31, 2008.

(51) Int. Cl. B60K 1/02; H02J 7/00

(52) U.S. Cl. 180/65.51; 320/107; 477/3

(57) ABSTRACT

A suspension module that includes a suspension component, a pair of wheel hubs coupled to the at least one suspension component and an auxiliary drive system. Each wheel hub is mounted to a vehicle wheel. The auxiliary drive system has a pair of drive units, an auxiliary battery, an auxiliary battery charger and a controller. Each of the drive units has an electric motor that is selectively operable for providing drive torque that is transmitted to an associated one of the wheel hubs. The controller is configured to operate in a first mode wherein an output of the auxiliary battery charger is employed to charge the auxiliary battery. The controller is also configured to operate in a second mode wherein the output of the auxiliary battery charger and an output of the auxiliary battery are employed to power the electric motors of the drive units.

### CROSS-REFERENCE TO RELATED APPLICATIONS

This application claims the benefit of U.S. Provisional Application No. 61/110,270, filed on Oct. 31, 2008. The entire disclosure of the above application is incorporated herein by reference.

### FIELD OF THE INVENTION

The present disclosure generally relates to hybrid electric vehicles (HEVs) and more particularly to a hybrid electric vehicle that employs parallel power supplies.

### BACKGROUND

U.S. patent application Ser. No. 11/415,457 entitled “Vehicle With Hybrid Power Train Providing Part-Time All-Wheel Drive”, the disclosure of which is hereby incorporated by reference as if fully set forth in detail herein, discloses a hybrid electric vehicle with electric motors that can be selectively operated to provide supplemental propulsive power. Some types of electric motors, such as AC induction motors, are capable of producing very significant levels of torque if provided a correspondingly high level of electric current. In typical HEV electric systems, the output torque of the electric motor(s) is limited by the amount of current that can be drawn from the battery that supplies electric power to the electric motor(s).

### SUMMARY

In one form, the present teachings provide suspension module that includes a suspension component, a pair of wheel hubs coupled to the at least one suspension component and an auxiliary drive system. Each wheel hub is mounted to a vehicle wheel. The auxiliary drive system has a pair of drive units, an auxiliary battery, an auxiliary battery charger and a controller. Each of the drive units has an electric motor that is selectively operable for providing drive torque that is transmitted to an associated one of the wheel hubs. The controller is configured to operate in a first mode wherein an output of the auxiliary battery charger is employed to charge the auxiliary battery. The controller is also configured to operate in a second mode wherein the output of the auxiliary battery charger and an output of the auxiliary battery are employed to power the electric motors of the drive units.

In another form, the present teachings provide a method for operating a vehicle. The vehicle has at least one suspension component, a pair of wheel hubs and an auxiliary drive system. The wheel hubs are coupled to the at least one suspension system and are configured to be mounted to a vehicle wheel. The auxiliary drive system has a pair of drive units, an auxiliary battery, an auxiliary battery charger. Each of the drive units has an electric motor that is selectively operable for providing drive torque that is transmitted to an associated one of the wheel hubs. The method includes: operating the auxiliary battery charger to charge the auxiliary battery; and providing electrical energy from both the auxiliary battery and the auxiliary battery charger to power the electric motors.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of an exemplary vehicle having a hybrid power train constructed in accordance with the teachings of the present disclosure;

FIG. 2 is a perspective view of a portion of the vehicle of FIG. 1 illustrating the hybrid power train in more detail;

FIG. 2 is a perspective view of a portion of the vehicle of FIG. 1 illustrating the hybrid power train in more detail;

FIG. 4 is a schematic illustration of an exemplary vehicle having another hybrid power train constructed in accordance with the teachings of the present disclosure.

### DETAILED DESCRIPTION OF THE VARIOUS EMBODIMENTS

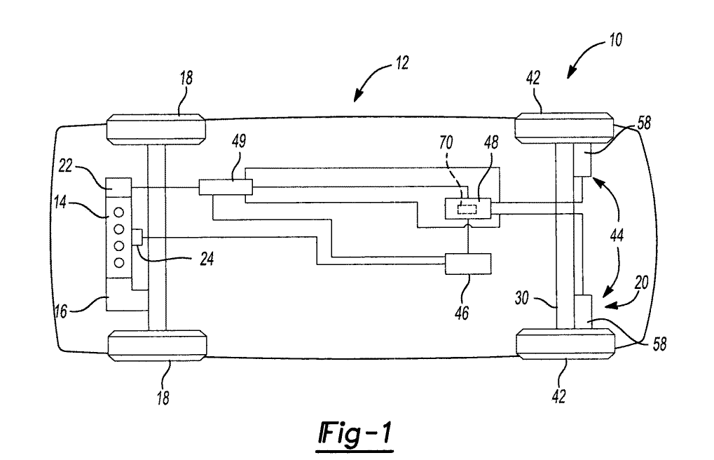

With reference to FIG. 1 of the drawings, a vehicle constructed in accordance with the teachings of the present disclosure is generally indicated by reference numeral 10. The vehicle 10 can include a body 12 to which an engine 14, a transmission 16, a set of front wheels 18 and a rear suspension module 20 can be coupled. In the particular example provided, the engine 14 and transmission 16 cooperate to provide drive torque to the set of front wheels 18. The engine 14 can include an engine electric system 22, which can be configured to supply DC voltage at a predetermined voltage (e.g., 12 VDC), and a vehicle controller 24.

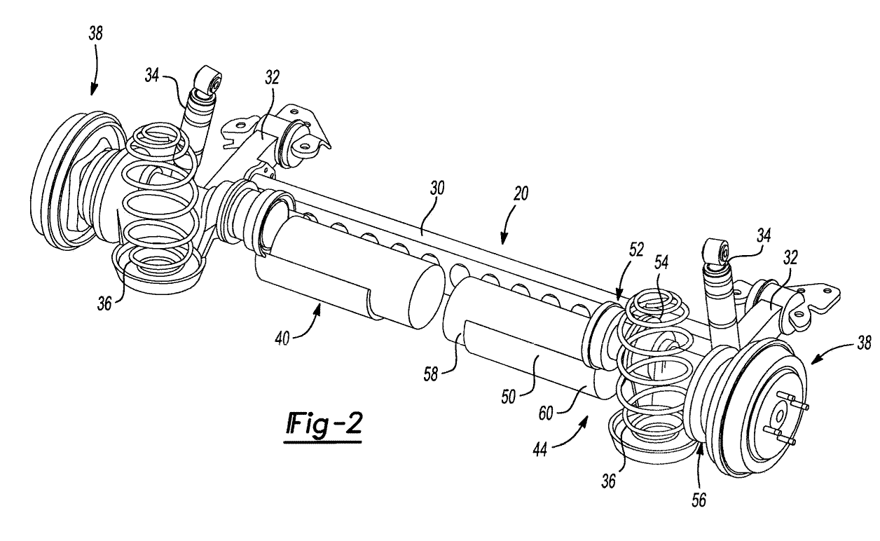

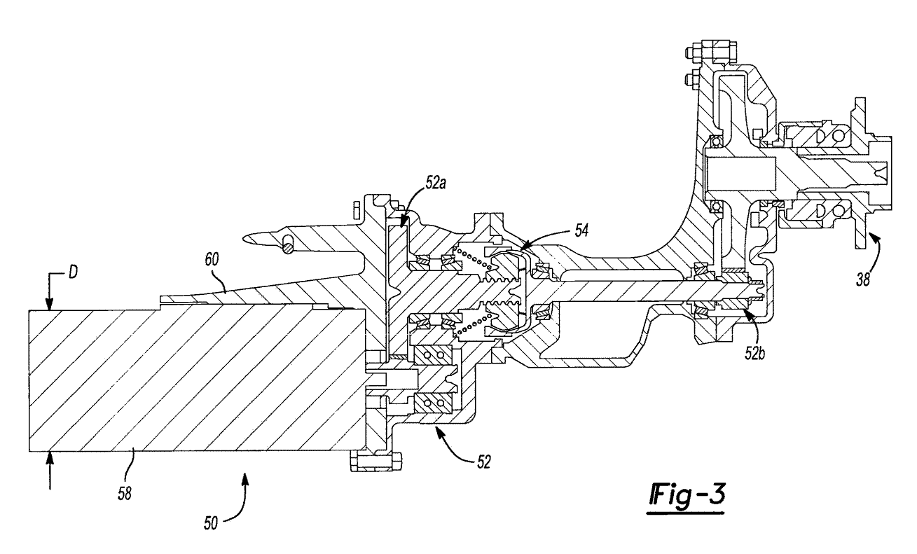

With additional reference to FIG. 2, the rear suspension module 20 can include a twist beam 30, a pair of control arms 32, a pair of shock absorbers 34, a pair of suspension springs 36, a pair of wheel hubs 38, an auxiliary drive system 40 and a pair of rear wheels 42. The control arms 32 can couple respective wheel hubs 38 to the body 12 of the vehicle 10, while the twist beam 30 can conventionally couple the control arms 32 to one another and the body 12 of the vehicle 10. The shock absorbers 34 and the suspension springs 36 can permit the rear suspension module 20 to be resiliently coupled to the vehicle body in a manner that is conventional and well known in the art.

The auxiliary drive system 40 can include a pair drive units 44, a motor controller 46, an auxiliary battery 48 and an auxiliary battery charger 49.

Each of the drive units 44 can include a motor assembly 50, at least one reduction gear set 52 and a clutch 54. With reference to FIGS. 2 and 3, the motor assembly 50 can include an electric motor 58 and a mounting bracket 60 that can couple the electric motor 58 to the twist beam 30. The electric motor 58 can be a low voltage (i.e., 50 volts) electric motor, such as a brush-type direct current (DC) motor, and can have an outer diameter D that is less than 8 inches and more preferably, less than about 6 inches. The electric motor 58 can have a maximum sustained torque of about 15 ft.-lbs. and more preferably about 20 to about 25 ft.-lbs. for short time periods, such as at least about 120 seconds. The electric motor 58 can output drive torque to the reduction gear set 52, which can be operable for performing a speed reduction and torque multiplication operation.

The reduction gear set 52 can include one or more stages of gear reduction and can provide an overall gear ratio of about 4:1 to about 25:1. In the particular example provided, the reduction gear set 52 utilizes a pair of gear stages 52a and 52b.

The clutch 54 can be any appropriate type of clutch, including an overrunning clutch, a slip clutch or a clutch having an inertia disk, actuator and pressure plates (e.g., a wet clutch). Moreover, it will be appreciated that the clutch could be actuated through various mechanical, hydraulic and/or electrical means. The clutch 54 can permit an associated) one of the rear wheels 42 (FIG. 1) to coast when an associated one of the electric motors 58 is not operated so that the rear wheels 42 (FIG. 1) do not “back drive” their associated electric motor 58. In the particular example provided, the clutch 54 is disposed between the stages 52a and 52b of the reduction gear set 52, but those of skill in the art will appreciate that the clutch 54 could be disposed between its associated wheel 42 (FIG. 1) and an output of the reduction gear set 52.

With renewed reference to FIGS. 1 and 2, the auxiliary battery 48 can comprise one or more low-voltage batteries (i.e., 50 volts), such as a 36 volt battery, and can be configured in a manner such that it tolerates deep cycling (i.e., the repetitive discharge of about 80% of the maximum stored power of the auxiliary battery 48). The auxiliary battery charger 49 can receive electrical power from the engine electric system 22 to charge the auxiliary battery 48. In the particular example provided, the auxiliary battery charger 49 includes a DC-DC converter 70 that can be employed to change the voltage of the electrical energy produced by the engine electric system 22 to a voltage that is compatible with the voltage requirements of the auxiliary battery 48. In the particular example provided, the DC-DC converter 70 performs a step-up function wherein the voltage of the electrical energy produced by the engine electric system 22 is stepped-up from 12 volts to 36 volts. It will be appreciated that construction of the vehicle electrical system in this manner permits a portion of the vehicle electrical system (not specifically shown or discussed herein) to be configured in a conventional and well known manner. Those of skill in the art will appreciate that if the remainder of the vehicle electrical system were to be compatible with the voltage of the auxiliary battery 48, the DC-DC converter 70 would not be necessary.

Other methods for charging the auxiliary battery 48 may be used. For example, the engine electric system 22 can be configured to provide an output with a voltage that is appropriate for charging the auxiliary battery 48. The other methods include, but are not limited to, deceleration regenerative charging, DC-DC generator charging, and plug-in charging. For example, the vehicle 10 may be configured to plug in to a standard AC electrical outlet to charge the auxiliary battery 48.

The motor controller 46 can be configured to control the distribution of electrical power within the auxiliary drive system 40 and to selectively activate the clutch 54 if the clutch 54 is not a mechanical (e.g., overrunning) clutch. For example, the motor controller 46 can control the distribution of electrical power from the auxiliary battery charger 49 to the auxiliary battery 48 to control the charging of the auxiliary battery 48. The motor controller 46 can control the distribution of electrical power between the auxiliary battery 48 and the electric motors 58 (i.e., from the auxiliary battery 48 to the electric motors 58 to drive the electric motors and from the electric motors 58 to the auxiliary battery 48 during regenerative braking). The motor controller 46 can also control the auxiliary battery charger 49 to provide electrical power directly to the electric motors 58 (in conjunction with electrical power provided to the electric motors 58 via the auxiliary battery 48).

The vehicle controller 24 can be coupled to the motor controller 46 and can be conventionally configured to control the operation of the engine 14 and the transmission 16. The vehicle controller 24 can receive and/or determine the following vehicle characteristics: left front wheel speed; right front wheel speed; left rear wheel speed; right rear wheel speed; throttle position; brake activation; gear shift position; voltage of the auxiliary battery 48, engine speed, vehicle speed, and ignition status (on/off). The vehicle controller 24 can provide the following outputs: motor enable signal, motor direction signal, motor speed signal, state of charge signal, and power in/out signal.

The motor enable signal may be generated by the vehicle controller 24 upon the occurrence of a predetermined event or sequence of events to cause the motor controller 46 to activate the electric motors 58. For example, the vehicle controller 24 can be configured to identify those situations where one or both of the front wheels 18 of the vehicle 10 are slipping. Slipping may be identified, for example, by determining whether a difference between the wheel speeds of the front wheels 18 exceeds a predetermined differential, or by determining whether a difference between a speed of the perimeter of each front wheel and the vehicle speed exceeds a predetermined differential. Additionally or alternatively, the vehicle controller 24 can be configured to identify those situations where rapid acceleration of the vehicle is desired. For example, the vehicle controller 24 can determine if the speed of the vehicle is below a predetermined threshold and the throttle of the engine is opened significantly thereby indicating that the operator of the vehicle desires that the vehicle accelerate relatively rapidly.

Generation of the motor enable signal can also be conditioned upon the occurrence of other events or conditions, such as a speed of the vehicle 10 is less than a predetermined speed threshold (e.g., 25 miles per hour), the ignition status is on, the gear selector (not shown) is in a predetermined position (e.g., a forward gear setting or a reverse gear setting), the voltage of the auxiliary battery 48 exceeds a predetermined threshold and the vehicle brakes (not shown) have not been actuated by the vehicle operator.

The motor direction signal can be generated by the vehicle controller 24 to designate the direction in which the electric motors 58 are to turn their respective rear wheels 42. The vehicle controller 24 can determine the motor direction signal (i.e., forward or reverse) based on the position of the gear selector (not shown). The motor speed signal can be generated by the vehicle controller 24 to designate a speed at which the rear wheels 42 (or a related component, such as the output shafts of the electric motors 58) are to turn. The state of charge signal can be generated by the motor controller 46 to designate those situations where the auxiliary battery 48 is charged to a predetermined level. The power in/out signal can be employed to communicate information to another control system or to the vehicle operator. In the example provided, the power in/out signal can be employed to light a telltale indicator (not shown) in the instrument panel (not shown) to inform the vehicle operator when electric motors 58 are employed to provide tractive power and/or to generate electrical energy.

The motor controller 46 can be configured such that it will not activate the electric motors 58 unless it receives the motor enable signal in addition to one or more of the motor direction signal, the motor speed signal and the state of charge signal. It will be appreciated that once activated, the electric motors 58 will produce supplementary power that will be output to the reduction gear set 52. If the clutch 54 is not a mechanical overrunning clutch, the motor controller 46 can operate the clutch 54 to transmit rotary power to the rear wheels 42 at an appropriate time (e.g., when the output shafts of the electric motors 58 are rotating sufficiently fast so as to drive the rear wheels 42).

The motor controller 46 can be configured to control the auxiliary battery 48 and the auxiliary battery charger 49 to supply electric power to the electric motors 58 when the electric motors 58 are to be activated. For example, the motor controller 46 can be configured to ordinarily control the operation of the electric motors 58 with the auxiliary battery 48 and to additionally employ electric power from the auxiliary battery charger 49 upon the occurrence of one or more predetermined conditions. Such predetermined conditions could include, for example, a state of charge of the auxiliary battery 48 that is below a first battery charge threshold and above a second battery charge threshold, a manual input from the vehicle operator (i.e., operation of the vehicle—in a “sport” mode) and/or a throttle position corresponding to the opening of the throttle in a manner that causes rapid acceleration. Furthermore, the motor controller 46 can be configured to control the operation of the electric motors 58 with electric power provided solely by the auxiliary battery charger 49 upon the occurrence of one or more predetermined conditions. Such predetermined conditions could include, for example, a state of charge of the auxiliary battery 48 that is below the second battery charge threshold, a fault within the auxiliary battery 48 (e.g., a faulty battery cell) and a fault in the electrical connection between the auxiliary battery 48 and the electric motors 58.

As the electric motors 58 are wired in parallel and are controlled via the DC voltage output by the motor controller 46 in the example provided, the electric motors 58 will function in a manner that is similar to a mechanical limited slip differential. More specifically, if one of the rear wheels 42 looses traction the current that is output by the motor controller 46 will decrease but as no change will occur in the DC voltage provided to the other electric motor 58, there will be little impact on the performance/operation of the electric motor 58 that is associated with the non-slipping rear wheel 42. It will be apparent to those of ordinary skill in the art that in the event that one or both of the rear wheels 42 loose traction, power to the associated electric motor 58 could be interrupted (to one or both of the electric motors 58) to permit the rear wheel or wheels 42 to gain traction.

Those of ordinary skill in the art will also appreciate that the electric motors 58 may be controlled via a single motor controller 46 in various other ways. For example, the motor controller may be configured to control the current that is delivered to the electric motors 58. Also, the electric motors 58 could be wired in series with one another and controlled by a single motor controller that is configured to control the DC voltage or current that is delivered to the electric motors. Those of ordinary skill in the art will also appreciate that the electric motors 58 need not be wired in parallel but could, in the alternative, be controlled by separate motor controllers 46. Configuration in this manner can permit each of the motor controllers 46 to independently identify wheel slip and to control their respective electric motors 58 in an appropriate manner.

It will be appreciated that the rear suspension module 20 is configured in a modular manner that is readily interchangeable with a standard (i.e., non-powered) rear suspension module. In this regard, the rear suspension module (20) and a standard rear suspension module can be coupled to the vehicle in a common manner. Accordingly, the configuration of the rear suspension module 20 is advantageous in that four-wheel drive capabilities can be provided in a relatively inexpensive and efficient manner.

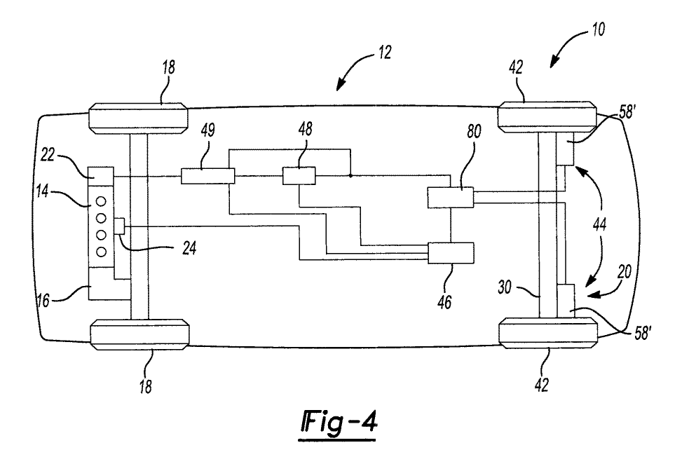

While the electric motors 58 have been described as brush-type DC motors, those of skill in the art will appreciate that other types of motors could be employed in the alternative. For example, in the example of FIG. 4, the electric motors 58′ are AC induction motors. The auxiliary drive system 40′ can be generally similar to the auxiliary drive system 40 (FIG. 1) described above, except that the auxiliary battery 48 and the auxiliary battery charger 49 can be configured to output electrical power to a DC-AC converter 80. The DC-AC converter 80 can convert the DC electric power provided thereto by the auxiliary battery 48 and/or the auxiliary battery charger 49 into AC power that can be provided to the electric motors 58′. The DC-AC converter 80 can also be employed to convert AC power provided by the electric motors 58′ (e.g., during a regenerative braking operation) into DC power that can be employed to charge the auxiliary battery 48.

While specific examples have been described in the specification and illustrated in the drawings, it will be understood by those of ordinary skill in the art that various changes may be made and equivalents may be substituted for elements thereof without departing from the scope of the present disclosure as defined in the claims. For example, it will be appreciated from this disclosure that the electric motor 58 could be an AC induction motor and/or that the clutch 54 could be another type of clutch, such as a slip clutch, or could be deleted altogether. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1. A suspension module comprising:
at least one suspension component;
a pair of wheel hubs that are coupled to the at least one suspension component, each wheel hub being adapted to be mounted to a vehicle wheel; and
an auxiliary drive system having a pair of drive units, an auxiliary battery, an auxiliary battery charger and a controller, each of the drive units having an electric motor that is selectively operable for providing drive torque that is transmitted to an associated one of the wheel hubs, the controller being configured to operate in a first mode wherein an output of the auxiliary battery charger is employed to charge the auxiliary battery; the controller also being configured to operate in a second mode wherein the output of the auxiliary battery charger and an output of the auxiliary battery are employed to power the electric motors of the drive units.

2. The suspension module of claim 1, wherein the controller is operable in a third mode in which only the output of the auxiliary battery charger is employed to power the electric motors of the drive units.

3. The suspension module of claim 2, wherein the controller is operable in a fourth mode in which an electrical output is generated by the electric motors to charge the auxiliary battery.

4. The suspension module of claim 1, wherein the electric motors are AC induction motors.

5. The suspension module of claim 5, wherein the auxiliary drive system further comprises a DC-AC converter that is disposed between the electric motors and the output of auxiliary battery charger.

6. The suspension module of claim 1, wherein the auxiliary battery charger includes a DC-DC converter.

7. The suspension module of claim 6, wherein an output of the DC-DC converter has a voltage that is less than about 50 VDC.

8. The suspension module of claim 1, wherein the controller is operable in a third mode in which an electrical output is generated by the electric motors to charge the auxiliary battery.

9. A method for operating a vehicle, the vehicle having at least one suspension component, a pair of wheel hubs and an auxiliary drive system, the wheel hubs being coupled to the at least one suspension system and being adapted to be mounted to a vehicle wheel, the auxiliary drive system having a pair of drive units, an auxiliary battery, an auxiliary battery charger, each of the drive units having an electric motor that is selectively operable for providing drive torque that is transmitted to an associated one of the wheel hubs, the method comprising:
operating the auxiliary battery charger to charge the auxiliary battery; and
providing electrical energy from both the auxiliary battery and the auxiliary battery charger to power the electric motors.

10. The method of claim 9, wherein prior to providing electrical energy from both the auxiliary battery and the auxiliary battery charger the method includes determining that the auxiliary battery is charged above a predetermined threshold.

11. The method of claim 10, further comprising providing electrical energy solely from the auxiliary battery charger if the auxiliary battery is not charged above the predetermined threshold.

12. The method of claim 11, wherein prior to providing electrical energy from both the auxiliary battery and the auxiliary battery charger the method includes determining from one or more vehicle characteristics that rapid acceleration is desired.

13. The method of claim 12, further comprising providing electrical energy solely from the auxiliary battery if rapid acceleration is not desired and the auxiliary battery is charged above the predetermined threshold.

14. The method of claim 9, wherein prior to providing electrical energy from both the auxiliary battery and the auxiliary battery charger the method includes determining from one or more vehicle characteristics that rapid acceleration is desired.

15. The method of claim 14, further comprising providing electrical energy solely from the auxiliary battery if rapid acceleration is not desired.

16. The method of claim 9, further comprising:
operating the electric motors to generate electric energy; and
charging the auxiliary battery with the energy generated by the electric motors.

17. A suspension module comprising: at least one suspension component;
a pair of wheel hubs that are coupled to the at least one suspension component, each wheel hub being adapted to be mounted to a vehicle wheel; and
an auxiliary drive system having a pair of drive units, an auxiliary battery, an auxiliary battery charger and a controller, each of the drive units having an electric motor that is selectively operable for providing drive torque that is transmitted to an associated one of the wheel hubs, the controller being configured to operate in a first mode wherein an output of the auxiliary battery charger is employed to charge the auxiliary battery, the controller also being configured to operate in a second mode wherein the output of the auxiliary battery charger and an output of the auxiliary battery are employed to power the electric motors of the drive units; wherein the controller is operable in a third mode in which only the output of the auxiliary battery charger is employed to power the electric motors of the drive units;
wherein the controller is operable in a fourth mode in which an electrical output is generated by the electric motors to charge the auxiliary battery;
wherein the auxiliary battery charger includes a DC-DC converter having an output voltage that is less than about 50 VDC; and
wherein the at least one suspension component is a twist-beam axle.

18. The suspension module of claim 17, wherein the electric motors are AC induction motors.

19. The suspension module of claim 18, wherein the auxiliary drive system further comprises a DC-AC converter that is disposed between the electric motors and the output of auxiliary battery charger.

20. The suspension module of claim 17, wherein each of the drive units includes a multi-stage reduction gear set.
